(19) United States
(12) Patent Application Publication
(10) Pub. No.: US 2020/0175492 A9
(43) Pub. Date: Jun. 4, 2020

(54) METHODS AND SYSTEMS FOR PERSON TO MERCHANT (P2M) PAYMENT TRANSACTIONS

(71) Applicant: MASTERCARD INTERNATIONAL INCORPORATED, Purchase, NY (US)

(72) Inventors: Vairag Jain, Uttar Pradesh (IN); Satya Sudipta Padhiary, Mumbai (IN); Mayank Prakash, Uttarakhand (IN)

(21) Appl. No.: 16/276,911

(22) Filed: Feb. 15, 2019

(30) Foreign Application Priority Data
Feb. 22, 2018 (SG) 10201801449T

(51) Int. Cl. G06Q 20/32; G06Q 20/34; G06Q 20/40; H04L 12/58

(52) U.S. Cl. CPC G06Q 20/325; G06Q 20/34; G06F 16/2282; H04L 51/04; G06Q 20/4012

(57) ABSTRACT

Embodiments provide methods, server systems, and user devices for facilitating person to merchant payment transactions. In an embodiment, the method includes receiving, by a server system associated with a payment network, a payment transaction request. The payment transaction request is initiated using a messaging protocol on a user device. The payment transaction request includes a merchant ID, a payment card selected from one or more payment cards, and a transaction amount. The method includes verifying, by the server system, the merchant ID from a database including a listing of a plurality of merchant information. Upon successful verification of the merchant ID, the method includes facilitating, by the server system, the payment transaction of the transaction amount from an issuer account of a user to an acquirer account of a merchant.

### CROSS REFERENCE TO RELATED APPLICATIONS

This patent application claims priority to Singapore Patent Application No. 10201801449T filed on Feb. 22, 2018, the disclosure of which is incorporated by reference herein in its entirety as part of the present application.

### BACKGROUND

The present disclosure relates to electronic payment transactions and, more particularly to, methods and systems for electronic payment transactions from Person to Merchant (P2M).

Wireless phone technology is used by smartphones and feature phones (hereinafter collectively also referred to as mobile phones). Smartphones usually include a large display, data connectivity, and an advanced processor to execute applications. For instance, 4G smartphones with Internet connectivity usually offer a wide variety of Internet-connected applications such as mobile banking applications for performing financial transactions (e.g., payment transaction). Feature phones, by contrast, offer basic features and are centered on voice connectivity rather than data connectivity. Some feature phones provide Internet connectivity with a browser. However, the browser may not provide the same features as applications available with a smartphone, and typing may be difficult using keypads of a feature phone. While smartphones are quite common in the developed world, feature phones still predominate in the developing countries.

There are many scenarios when a user/customer willing to pay a merchant electronically is not capable of doing so for the reasons such as, the customer does not have a smartphone, the internet on his phone is not working properly, the customer is living in a rural area where reception of continuous internet connectivity is difficult, or the merchant is a local and small vendor who does not afford the cost of point-of-sale (POS) terminal. Currently, some mobile services carriers offer Unstructured Supplementary Service Data (USSD) messaging technology for providing mobile banking services to the users using their mobile phones. Immediate Payment Service (IMPS) is an existing electronic fund transfer system that involves an interbank electronic instant mobile money transfer service using mobile phone or Internet of the user.

FIG. 1 shows an example representation 100 of an existing process flow of an IMPS fund transfer displayed on a mobile phone of a user with corresponding User Interfaces (UIs) using USSD technology. The communication between the user and his/her bank occurs using the USSD session via the mobile services carrier. The user enters a dedicated USSD code provided by the bank for initiating the transaction. The mobile services carrier forwards the USSD code to the bank server (i.e., issuer bank server) for authentication. In response, the bank server (associated with the bank—e.g., Corporation bank) displays a list of options for user selection using a UI 105 upon authentication of the USSD code. As shown, the user has selected ‘option 3’ for initiating IMPS fund transfer. Next, the user selects ‘option 2’ for IMPS fund transfer to account as shown in UI 110. The user is requested by the bank server/bank to enter beneficiary's account number (see, 039501519877) as shown in the UI 115. The user is then requested to enter Indian Financial System Code (IFSC) of the beneficiary's bank. The user enters the IFSC (see, HDFC0001234) as shown in the UI 120. Next, the user enters the transaction amount (see, 200 INR) as shown in the UI 125. The user enters mobile banking personal identification number (MPIN) issued by the bank for authenticating the transaction using the UI 130. The bank verifies the MPIN entered by the user and transfers the transaction amount from user's account to the beneficiary's account in real time. The user receives a message of the successful transaction from the bank as shown in the UI 135 and the USSD session gets over.

Alternatively, the user may select ‘option 1’ on the UI 110 to transfer the transaction amount using mobile number of the beneficiary. Based on such selection, instead of the IFSC, the user may be requested to enter mobile money identifier (MMID) of the beneficiary. Further, instead of the beneficiary's account number, the user may be requested to enter a mobile number of the beneficiary to process the transaction.

In both the options displayed on the UI 110, the user needs to receive two parameters from the beneficiary—the account number (12 characters) and the IFSC (11 characters) or the mobile number (10 characters) and the MMID (7 characters). This is a time-consuming process to complete a payment transaction. Further, the IMPS based fund transfer utilizes only bank accounts as the source of fund and therefore the user needs to maintain a sufficient amount of money in his bank account before initiating the payment transaction.

Therefore, there is a need to provide solution to above mentioned drawbacks of currently established electronic payment transaction systems. There is a need to provide faster and less complex transaction flow for enhancing the user experience of payment transactions. Further, there is a need to overcome limitations of having a need to use only bank account (i.e. debit card) based transfer for processing the payment transactions.

### BRIEF DESCRIPTION

Various embodiments of the present disclosure provide systems, methods, electronic devices, and computer program products for facilitating P2M payment transactions.

An embodiment of the present disclosure provides a method for facilitating P2M payment transactions. The method includes receiving, by a server system associated with a payment network, a payment transaction request. The payment transaction request is initiated using a messaging protocol on a user device of a user. The payment transaction request includes at least a merchant ID associated with a merchant and a transaction amount. The method further includes verifying, by the server system, the merchant ID from a mapping table including a plurality of merchant information associated with a plurality of merchants. Upon successful verification of the merchant ID from the mapping table, the method includes, facilitating, by the server system, a payment transaction of the transaction amount from an issuer account of the user to an acquirer account of the merchant.

Another embodiment of the present disclosure provides a server system for facilitating P2M payment transactions in a payment network. The server system includes a communication interface, a memory, and a processor communicably coupled to the communication interface and the memory. The communication interface receives a payment transaction request. The payment transaction request is initiated using a messaging protocol on a user device of a user. The payment transaction request includes at least a merchant ID associated with a merchant and a transaction amount. The memory includes executable instructions. The processor is configured to execute the instructions to cause the server system to at least verify the merchant ID from a mapping table including a plurality of merchant information associated with a plurality of merchants. Upon successful verification of the merchant ID from the mapping table, the server system is also caused to facilitate a payment transaction of the transaction amount from an issuer account of the user to an acquirer account of the merchant.

Another embodiment of the present disclosure provides a server system for facilitating P2M payment transactions in a payment network. The server system includes a database, a communication interface, a memory, and a processor. The database is configured to store a mapping table including a plurality of merchant information associated with a plurality of merchants. The communication interface receives a payment transaction request. The payment transaction request is initiated using an Unstructured Supplementary Service Data (USSD) protocol on a user device of a user. The payment transaction request includes at least a merchant ID associated with a merchant and a transaction amount. The memory includes executable instructions. The processor is configured to execute the instructions to cause to server system to verify the merchant ID from the mapping table. Upon successful verification of the merchant ID from the mapping table, the server system is also caused to facilitate a payment transaction of the transaction amount from an issuer account of the user to an acquirer account of the merchant.

### BRIEF DESCRIPTION OF THE DRAWINGS

For a more complete understanding of example embodiments of the present technology, reference is now made to the following descriptions taken in connection with the accompanying drawings in which:

FIG. 1 shows an example representation of an existing process flow of an immediate payment service (IMPS) fund transfer displayed on a mobile phone of a user with corresponding User Interfaces (UIs) using unstructured supplementary service data (USSD) technology;

FIG. 2 illustrates an example representation of an environment, in which at least some example embodiments of the present disclosure can be implemented;

FIG. 3 represents a sequence flow diagram representing a completion of a payment transaction using a merchant ID of a merchant, in accordance with an example embodiment;

FIGS. 4A and 4B show simplified schematic representations of a UI of a person to merchant (P2M) payment transaction using user's mobile phone, in accordance with an example embodiment;

FIGS. 5A, 5B, and 5C show simplified schematic representations of a UI of a P2M payment transaction using user's mobile phone, in accordance with an example embodiment;

FIG. 6 represents a sequence flow diagram representing an assignment of a merchant ID to a merchant, in accordance with another example embodiment;

FIG. 7 represents a simplified schematic representation of a mapping table stored in a payment server for verifying a merchant ID for a completion of a payment transaction, in accordance with an example embodiment;

FIG. 8 shows a simplified schematic representation of a UI of a P2M payment transaction using user's mobile phone, in accordance with an example embodiment;

FIG. 9 illustrates a flow diagram of a method for facilitating P2M payment transaction, in accordance with an example embodiment;

FIG. 10 is a simplified block diagram of a server system used for P2M payment transaction, in accordance with one embodiment;

FIG. 11 is a simplified block diagram of an issuer server for P2M payment transaction, in accordance with one embodiment of the present disclosure;

FIG. 12 is a simplified block diagram of an acquirer server used for P2M payment transaction, in accordance with one embodiment of the present disclosure;

FIG. 13 is a simplified block diagram of a payment server used for P2M payment transaction, in accordance with one embodiment of the present disclosure; and

FIG. 14 shows simplified block diagram of a user device, for example, a mobile phone capable of implementing at least some embodiments.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “payment account” used throughout the description refers to a financial account that is used to fund the financial transaction (interchangeably referred to as “payment transaction”). Examples of the payment account include, but are not limited to a savings account, a credit account, a checking account, and a virtual payment account. The payment account may be associated with an entity such as an individual person, a family, a commercial entity, a company, a corporation, a governmental entity, a non-profit organization, and the like. In some scenarios, a payment account may be a virtual or temporary payment account that can be mapped or linked to a primary payment account, such as those accounts managed by PayPal®, and the like.

The term “payment card”, used throughout the description, refers to a physical or virtual card linked with a financial or payment account that may be used to fund a financial transaction to a merchant or any such facility via the associated payment account. Examples of the payment card include, but are not limited to, debit cards, credit cards, prepaid cards, virtual payment numbers, virtual card numbers, forex cards, charge cards, and stored-value cards. A payment card may be a physical card that may be presented to the merchant for funding the payment. Alternatively, or additionally, the payment card may be embodied in form of data stored in a user device, where the data is associated with payment account such that the data can be used to process the financial transaction between the payment account and a merchant's financial account.

The term “payment network”, used throughout the description, refers to a network or collection of systems used for transfer of funds through use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by Mastercard®, VISA®, Discover®, American Express®, etc.

### OVERVIEW

Various example embodiments of the present disclosure provide methods, systems, user devices, and computer program products for accommodating a large population of mobile phone users irrespective of using a feature phone or a smartphone by providing a less complicated and much faster payment transaction process for payment transactions to the merchants.

In various example embodiments, the present disclosure provides person to merchant (P2M) payment transaction using a user device (such as a mobile phone) via a messaging protocol. Examples of the messaging protocol include Unstructured Supplementary Service Data (USSD) or Short Message Service (SMS) based protocol/technology. In one embodiment, the user enters a merchant ID provided by the merchant for processing the payment transaction for purchasing goods or services from the merchant using the user device. Along with the merchant ID, the user is requested to enter other payment transaction details such as transaction amount, an authorization personal identification number PIN (such as a mobile personal identification number—MPIN) and a mode of payment such as a selection of a payment card for continuing with the payment transaction.

The mobile phone of the user may be configured to send the details of the prospective financial transaction including the merchant ID, the transaction amount, the MPIN, and the payment card selection to an associated issuer system (e.g., a financial entity/originating institute with which the user is registered for USSD based payment transactions). The issuer system and an acquirer system (e.g., a financial entity/receiving institute with which the merchant has payment account) communicate among them using a payment network, authenticate the details of payment transaction such as payment card details of the user, the transaction amount and verification of merchant ID. Such authentication is made for the prospective payment transaction at the merchant facility for a user willing to pay the transaction amount for purchase of a product or a service from the merchant facility using electronic payment transaction system.

Verification of the merchant ID is facilitated by a payment server associated with the payment network. The payment server may be configured to generate and maintain a mapping table in a database. The mapping table may include a listing of a plurality of merchant information. Each merchant information may further include a plurality of parameters associated with the merchant (hereinafter referred to as merchant parameters) and the merchant ID assigned to the merchant. Some non-exhaustive examples of the merchant parameters include a merchant name, a merchant category code, a merchant city, a merchant postal code, a merchant brand name, a merchant primary account number (PAN), a payment network assigned merchant ID such as Mastercard assigned merchant ID (MAID), and a request ID. The payment server retrieves a parameter (e.g., the merchant PAN) mapped to the merchant ID from the mapping table during the on-going payment transaction between the user/customer and merchant, and thereafter authenticates the merchant ID for the payment transaction.

Once the verification of the details of the financial transaction is completed, the payment server is configured to facilitate transfer of the transaction amount from the issuer system to the acquirer system. Since the user has to enter only the merchant ID of a predefined number of characters (e.g., of eight characters) for processing the payment transaction compared to the IMPS based fund transfer system, it becomes easier for the user to follow the transaction process. Further, the user does not have to worry about maintaining balance in his/her account for initiating the payment transaction as the user is given an option of selecting a payment card of his choice to pay for the transaction amount.

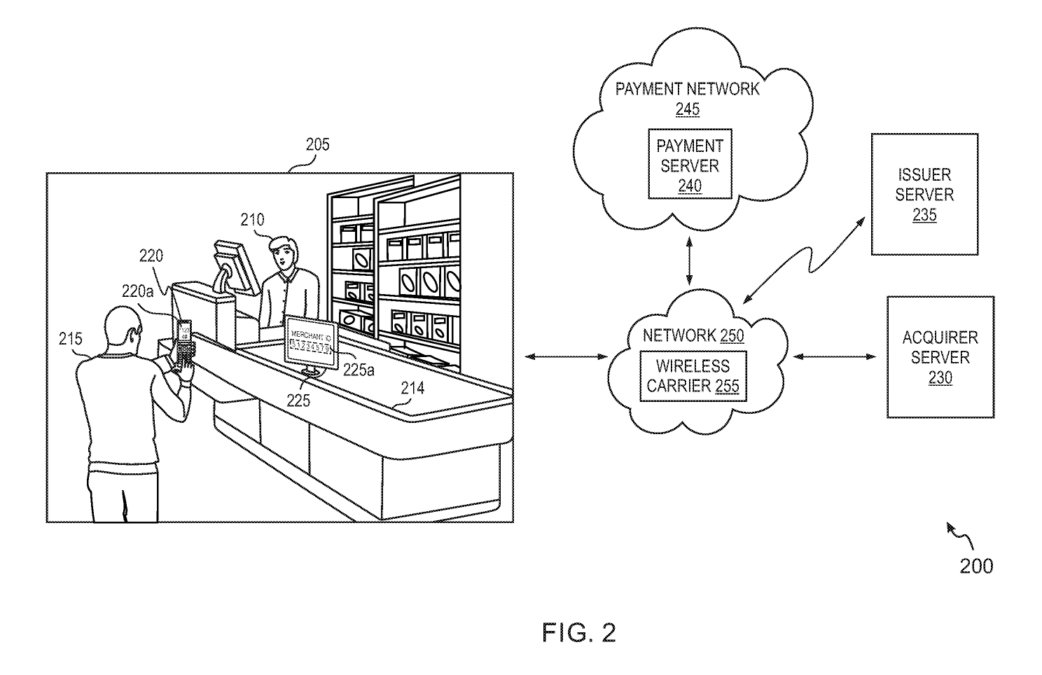

Various example embodiments of the present disclosure are described hereinafter with reference to FIGS. 2 to 14.

FIG. 2 illustrates an example representation of an environment 200, in which at least some example embodiments of the present disclosure can be implemented. In the illustrated embodiment, a facility 205 is shown. Examples of the facility 205 may include any retail shop, supermarket or establishment, government and/or private agencies, ticket counters, or any such place or establishment where users visit for performing financial transaction in exchange of any goods and/or services or any transaction that requires financial transaction between the user and the facility 205.

As can be seen from the environment 200, a customer 215 (hereinafter referred to as user 215) is standing near a payment desk 214 to make the financial transaction to a merchant 210 for a product purchased by the user 215 from the facility 205. The merchant 210 has placed a display board 225 with a merchant ID 225a (e.g., 51234579) which is uniquely associated with the merchant 210. The merchant ID 225a can be placed at one or more other places of the facility 205 so as to make it easily visible to the users. For instance, the merchant ID can be pasted on wall, can be mounted on queue dividers, or displayed on a display screen in the facility 205. The user 215 is shown to have entered a dedicated USSD code 220a (e.g., *1234#) on his user device 220 such as a mobile phone 220. The mobile phone 220 can be a feature phone with limited functionalities or a smartphone with internet connectivity. In other embodiments, the user device 220 can be any electronic device capable of utilizing USSD technology for payment transactions.

As the user 215 initiates a payment transaction using the USSD code 220a, the user 215 may be requested to enter payment transaction details such as transaction amount, selection of a payment card, merchant ID 225a, and the like. In a non-limiting example, authentication of the user's payment card for making a transaction of ‘X’ amount and verification of the merchant ID 225a to facilitate completion of the payment transaction is performed by a combination of an issuer server 235, an acquirer server 230, and a payment server 240. In one embodiment, the payment server 240 is associated with a payment network 245. The payment network 245 may be used by payment cards issuing authorities as a payment interchange network. Examples of payment interchange network include, but not limited to, Mastercard® payment system interchange network. The Mastercard® payment system interchange network is a proprietary communications standard promulgated by Mastercard International Incorporated® for the exchange of financial transaction data between financial institutions that are members of Mastercard International Incorporated®. (Mastercard is a registered trademark of Mastercard International Incorporated located in Purchase, N.Y.).

The issuer server 235 is associated with a financial institution normally called as an “issuer bank” or “issuing bank” or simply “issuer”, in which the user 215 may have an account, which issues a payment card, such as a credit card or a debit card, and provides USSD based electronic payment transaction facility, to the user 215. The payment cards are linked to the user's account. The user 215 being the cardholder, can use any of the payment cards to tender payment for a purchase from the merchant 210.

To accept payment with the payment card, the merchant 210 must normally establish an account with a financial institution that is part of the financial payment system. This financial institution is usually called the “merchant bank” or the “acquiring bank” or “acquirer bank” or simply “acquirer”. The acquirer server 230 is associated with the acquirer bank.

The user device (i.e., the mobile phone 220 of the user 215), a merchant device (such as a desktop computer), the issuer server 235, the acquirer server 230, and the payment server 240 communicate with one another using a network 250. Examples of the network 250 may include any type of wired network, wireless network, or a combination of wired and wireless networks. A wireless network may be a wireless local area network (“WLAN”), a wireless wide area network (“WWAN”), or any other type of wireless network now known or later developed. Additionally, the network 250 may be or include the Internet, intranets, extranets, microwave networks, satellite communications, cellular systems, personal communication services (“PCS”), infrared communications, global area networks, or other suitable networks, etc., or any combination of two or more such networks.

The payment transaction using USSD technology is facilitated by a wireless carrier 255 such as a mobile network operator or a cellular company that delivers wireless communication services such as USSD messaging or SMS messaging to the users of the mobile phone. Though the present disclosure is explained utilizing the USSD based payment transactions, in various embodiments, the SMS based payment transactions, or a SIM Tool Kit (STK) application of the mobile phone 220 can be used without deviating from the scope of the disclosure.

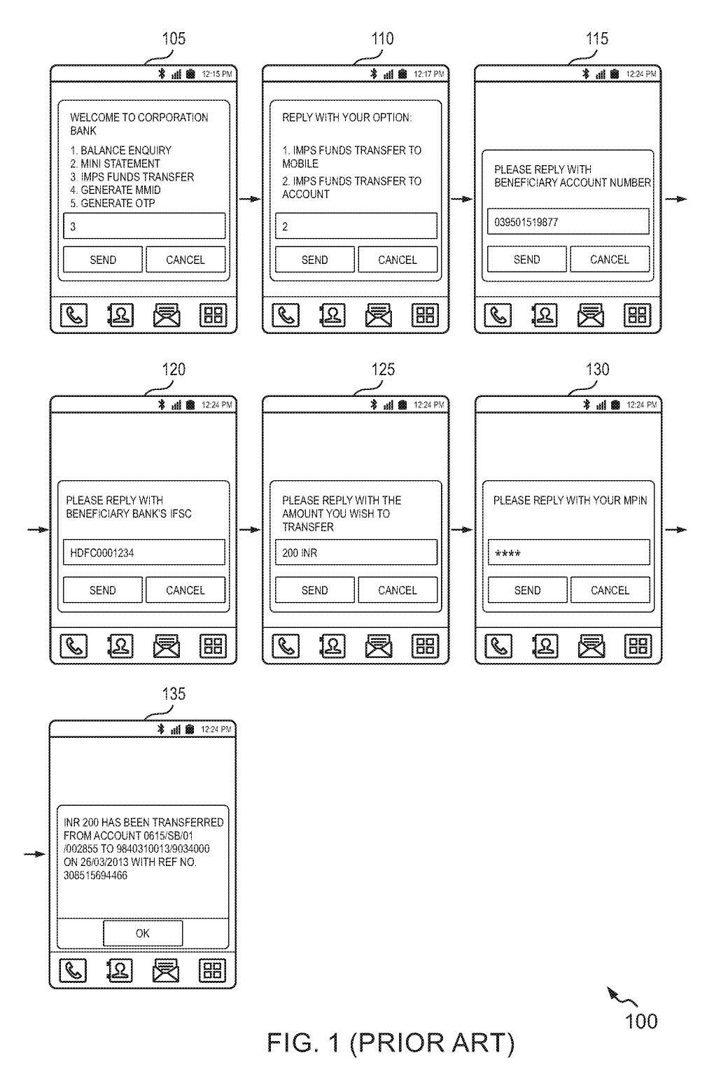

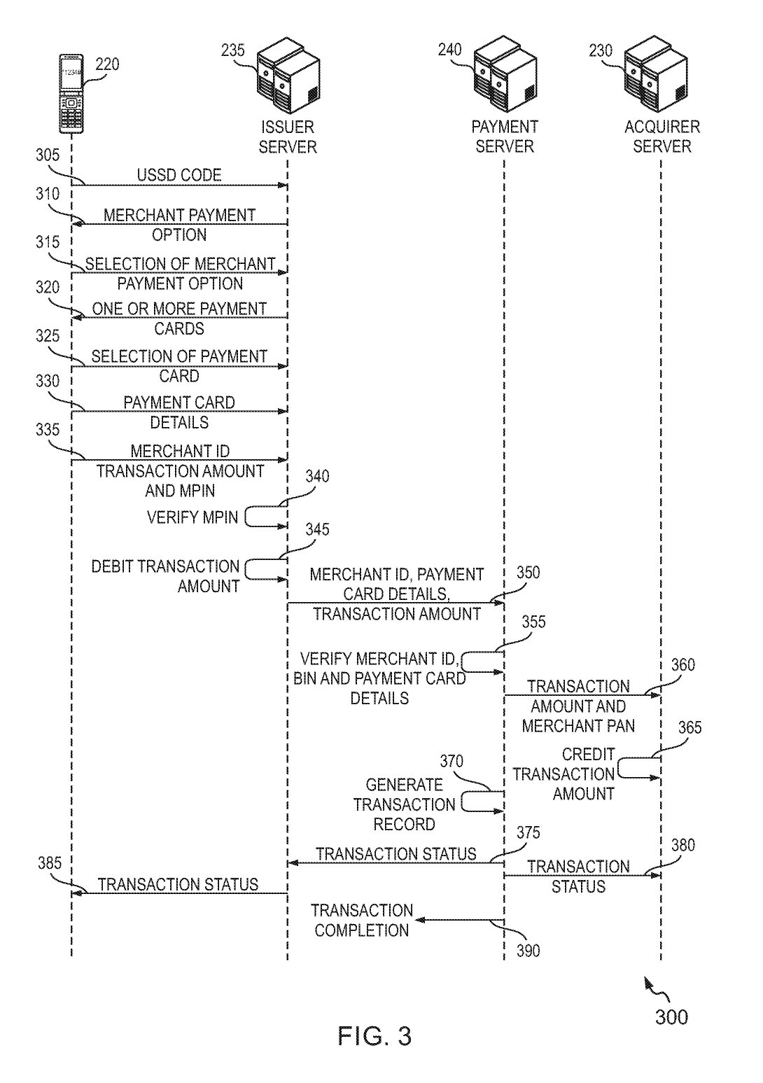

Since the user 215 is needed to only enter a merchant ID 225a (e.g., 8 characters) of the merchant 210 which is readily available at the payment desk 214, the overall transaction flow is effortless for completing the payment transaction. In scenarios when the user 215 has zero balance in his account, he can still pay using a credit card, as issuing authorities of credit allows free credit period of, for example, 50 days. Also, the user 215 may have other motivations to use a credit card such as collecting reward points to avail more discounted offers and the like. Such flexibility is missing in IMPS based payment transactions (explained with reference to FIG. 1) as the user 215 has to stick to conventional methods of using only bank account based payment transactions. Some non-exhaustive example embodiments of completing P2M payment transactions using merchant ID and payment cards are described with reference to FIGS. 3 to 8.

FIG. 3 represents a sequence flow diagram 300 representing a completion of a payment transaction through a messaging protocol using a merchant ID of a merchant, in accordance with an example embodiment of the present disclosure. At 305, a user (such as the user 215) enters a USSD code (e.g., USSD code 220a of FIG. 2) on his mobile phone 220 to initiate a payment transaction. This USSD code is transmitted by the wireless carrier 255 associated with the mobile network operator of the mobile phone 220 to the issuer server 235 associated with the issuer bank of the user. At 310, the issuer server 235, upon verifying the USSD code, facilitates display of at least one option (e.g., by transmitting a message including the options to the user device) related to ‘merchant payment’ on display screen/UI of the mobile phone 220 for user selection. In various embodiments, a plurality of options can be displayed such as account balance inquiry, mini account statement, one-time password (OTP) generation, and the like for user selection.

At 315, the user selects a ‘merchant payment’ option from the list of options displayed by the issuer server 235 using the UI on the mobile phone 220. At 320, the issuer server 235 is configured to display one or more payment cards associated with the user account/issuer account of the user for user selection. Examples of payment cards include a debit card, a credit card, a prepaid card, and the like. At 325, the user selects a choice of his payment card for processing the transaction amount through that card. For instance, the user may select a prepaid card. A prepaid card is much simpler to get compared to opening a bank account as the prepaid card requires minimal documentation for authorization. Alternatively, the prepaid card may be a gift card received by the user from a friend. In that case, the user only need to enter the card number associated with the prepaid card to pay the transaction amount. In contrast, the IMPS based payment transaction (existing known technique described with reference to FIG. 1) can only enable merchant payment based on a full know your customer (KYC) form received by the issuer bank from the user.

The issuer server 235 may facilitate another UI using which the user may enter additional payment card details for the selected payment card (see, operation 330). Examples of the payment card details include a card number (e.g., xxxx xxxx xxxx xxxx where ‘x’ is an integral number) of the payment card, user's payment account number (e.g., xxxxxxxx), or any identification number associated with the payment card. Next, at 335, the user is requested to enter a merchant ID of the merchant, a transaction amount and an MPIN using one or more corresponding UIs on the mobile phone 220 as displayed by the issuer server 235 via the wireless carrier 255 using the USSD technology. The merchant ID can be any numerical, alphanumerical, code or any identifier that is unique to identify the merchant. MPIN is a four-digit code issued by the issuer bank to the user while registering for the USSD based electronic payment transactions. MPIN is used to authenticate the user's identity and association with the issuer bank.

At 340, the issuer server 235 verifies the MPIN entered by the user. In one example embodiment, the issuer server 235 retrieves additional information associated with the selected payment card for additional verification of the payment card. Upon successful verification of the MPIN, at 345, the issuer server 235 debits the transaction amount entered by the user from his bank account by approving the transaction amount for the payment transaction. If the MPIN entered by the user is incorrect, the issuer server 235 is configured to request the user to re-enter the MPIN using a corresponding UI.

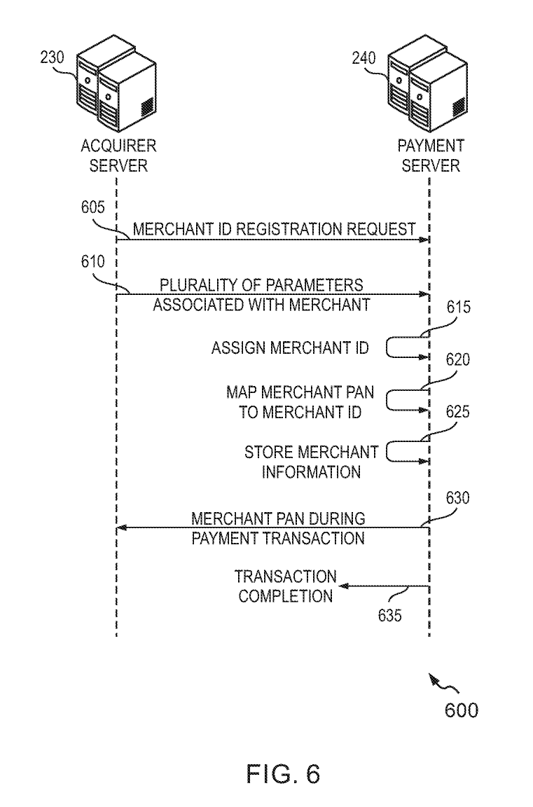

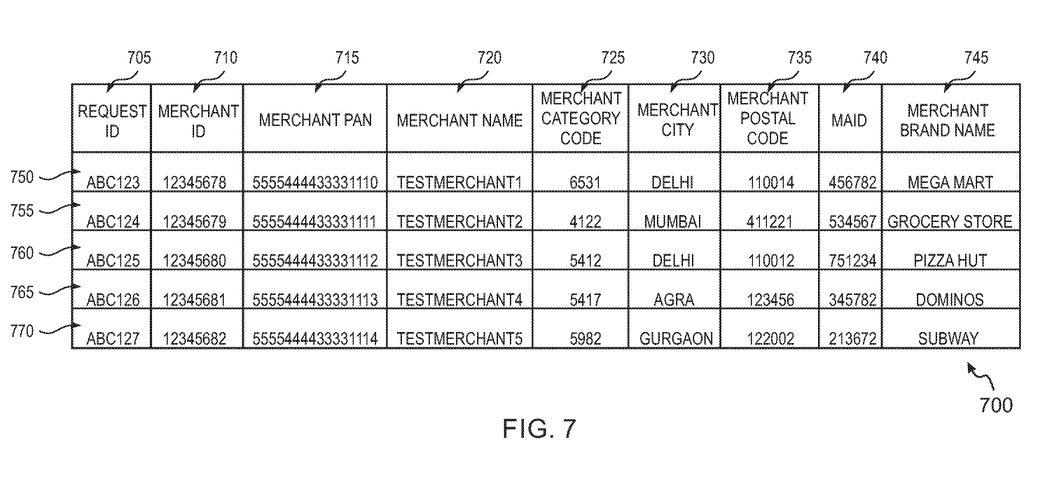

At 350, the issuer bank 235 is configured to send the merchant ID, the payment card details, and the transaction amount entered by the user to the payment server 240 over a network such as the network 250. At 355, the payment server 240 verifies the merchant ID, the bank identification number (BIN), and the payment card details. BINS are the first six-digits of the account number or payment card number to identify the issuing institution for the account and to ensure that each transaction is routed correctly. The merchant ID verification is done by the payment server 240 using a mapping table generated and stored in a database accessible to the payment server 240. The mapping table includes a listing of plurality of merchant information. The merchant information associated with a merchant includes the merchant ID assigned to the merchant by the payment server 240 along with a plurality of merchant parameters for the merchant. Examples of the parameters associated with the merchant include a merchant name, a merchant category code, a merchant city, a merchant postal code, a merchant brand name, a merchant primary account number (PAN), an MAID, and a request ID. Generation of the mapping table is explained in detail with reference to FIGS. 6 and 7 later.

Further, the payment server 240 verifies the payment card number and checks whether the cardholder's payment account is in good standing and whether the prospective purchase is covered by the cardholder's available credit line or account balance. In other embodiments, this operation may be performed by the issuer server 235 immediately upon receiving the payment card details from the user at operation 330. Only upon verification of payment card details, the issuer server 235 may send the selected payment card to the payment server 240.

In one embodiment, the payment server 240 may hold the transaction amount into the database and a charge may not be posted immediately to the user's account because bankcard associations, such as Mastercard International Incorporated®, have promulgated rules that do not allow a merchant to charge, or “capture,” a transaction until goods are shipped or services are delivered.

At 360, the payment server 240 sends the held transaction amount to the acquirer server 230 along with the merchant PAN retrieved from the mapping table. The merchant PAN is mapped to the merchant ID of the merchant. In other embodiments, instead of merchant PAN, any other merchant parameter can be retrieved and sent to the acquirer server 230 that can assist in crediting the transaction amount in the acquirer account of the merchant.

At 365, the acquirer server 230 credits the transaction amount to the merchant account using the merchant PAN. The acquirer server 230 may notify the payment server 240 of crediting of the payment transaction. At 370, the payment server 240 generates a transaction record. The transaction record includes a transaction status (i.e., successful, failure, or pending) of the payment transaction. For example, if the transaction fails for some reason, the payment server 240 reverses the transaction amount held by it or cleared by the issuer server 235 back to the issuer account of the user.

At 375, the payment server 240 sends the transaction status to the issuer server 235. At 380, the payment server 240 sends the transaction status to the acquirer server 230. At 385, the issuer server 235 sends the transaction status further to the mobile phone 220 of the user via the wireless carrier 255. In one embodiment, if the merchant is using a dedicated application facilitated by the payment server 240 in his device, the merchant may be immediately enabled to view the transaction status using the application on his device. The merchant may access the application using a web link as well, instead of having a need to install the application on his device. In other embodiments, the merchant may be notified using an SMS from the acquirer server 230 of the transaction status. The payment transaction completes at operation 390.

After a transaction is captured by the payment server 240, the transaction is settled between the merchant (e.g., the merchant 210 of FIG. 2), the acquirer bank, and the issuer bank. Settlement refers to the transfer of financial data or funds between the merchant's account, the acquirer bank, and the issuer bank related to the transaction. Usually, transactions are captured and accumulated into a “batch”, which is settled as a group. The actual transaction amount used by the user can be settled in batches even after the user leaves the facility 205.

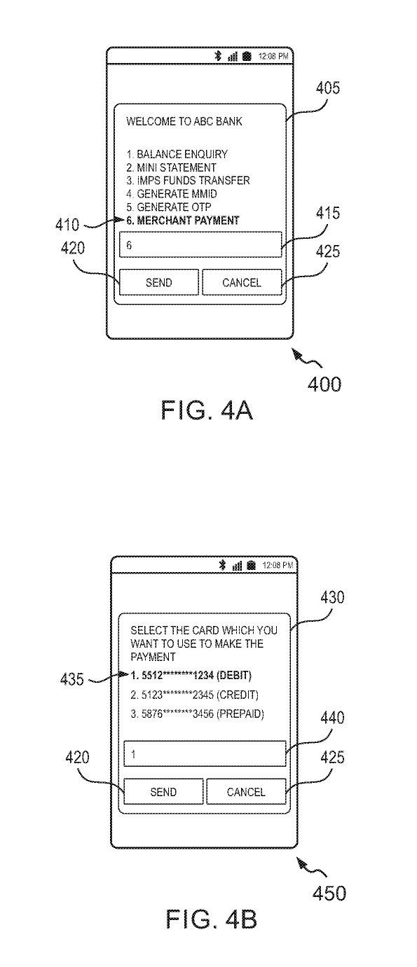

FIG. 4A shows a simplified schematic representation of a UI 400 of a person to merchant (P2M) payment transaction using user's mobile phone 220, in accordance with an example embodiment. In the illustrated embodiment, the UI 400 displays a menu 405 that includes a plurality of options received from the issuer server 235 (associated with ‘ABC Bank’) after verification of the USSD code entered by the user to initiate the payment transaction (i.e., after operation 305 of FIG. 3). More specifically, UI 400 corresponds to operations 310 and 315 of the sequence flow 300 of FIG. 3. As shown, among various other options, an option 410 represents ‘6. merchant payment’. Other options may include account balance enquiry, mini account statement, IMPS fund transfer, MMID generation, OTP generation, and the like. The user may be enabled to enter a respective number represented with an option to select an option. As shown, the user has entered ‘6’ in a form field 415 as a choice of his selected option. The user may click a button 420 labeled ‘Send’ to submit the entry input made in the form field 415. Alternatively, the user may click a button 425 labeled ‘Cancel’ to cancel the payment transaction.

In an embodiment, the wireless carrier 255 may be configured to send the entry input ‘6’ to the issuer server 235. The issuer server 235 is configured to facilitate a next set of options suitable to the entry input ‘6’ using a corresponding UI. For example, if the user had entered ‘1’ in the form field 415, the issuer server 235 would have displayed available balance amount of the user account in the next UI. For the entry input ‘6’, the issuer server 235 may display a next UI corresponding to one or more payment cards associated with the user account for user selection. A corresponding UI 450 is explained with reference to FIG. 4B.

FIG. 4B shows a simplified schematic representation of a UI 450 displayed on the mobile phone 220 illustrating a list of payment cards associated with user account, in accordance with one embodiment of the present disclosure. More specifically, the UI 450 represents operations 320 and 325 of the sequence flow 300 of FIG. 3. The UI 450 displays a menu 430 that includes one or more payment cards. Payment cards are depicted using their type, such as a debit card, a credit card, and a prepaid card in the menu 430. The user is enabled to select the choice of his payment card by entering the representative number associated with the card in a form field 440. Among other payment cards, a debit card 435 (exemplarily depicted as 5512********1234) is shown as selected by the user by entering ‘1’ in the form field 440. The user may click the button 420 to submit the selection of the debit card 435. In other examples, the user may select other payment cards such as credit card through entry input ‘2’ or a prepaid card through entry input ‘3’ using the form field 440.

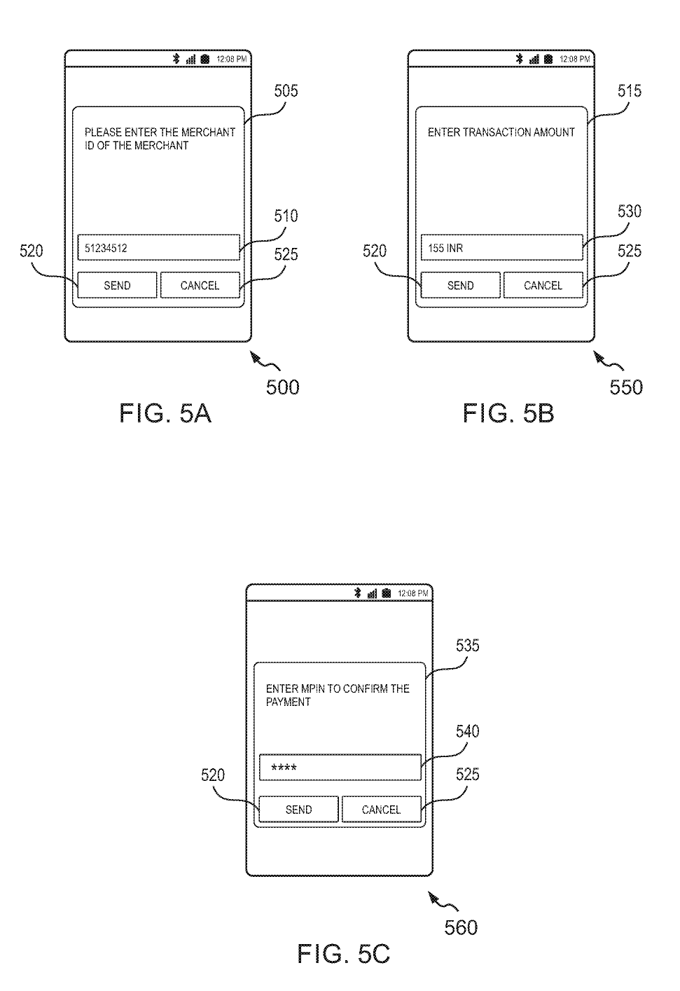

FIGS. 5A, 5B, and 5C show simplified schematic representations of a UI of a P2M payment transaction using user's mobile phone, in accordance with an example embodiment of the present disclosure. More specifically, FIGS. 5A, 5B, and 5C show respective UIs representing operation 335 of the sequence flow 300 of FIG. 3. FIG. 5A represents a UI 500 displayed by the issuer server 235 on the mobile phone 220 of the user via the wireless carrier 255.

The UI 500 displays a widget 505 that includes a form field 510 using which the user can enter a merchant ID (exemplarily depicted as 51234512) associated with the merchant. As explained with reference to FIG. 2, a merchant ID such as the merchant ID 225a can be posted by the merchant 210 at the payment desk 214/the checkout counter for the customers to view and use it for payment transactions. The user can click a button 520 labeled ‘Send’ to submit the entry input of the merchant ID. Else, the user can click a button 525 labeled ‘Cancel’ to cancel the transaction at any time.

Alternatively, the user can note down/store the merchant ID of the merchant in his mobile phone 220 and use it from any location other than the merchant facility 205 to process the payment transaction. In one embodiment, the issuer server 235 upon first time receiving the merchant ID from the user using the USSD technology, may be configured to store the merchant ID in its database for future retrieval. In that case, the UI 500 may be configured to include a drop-down list (not shown) with title ‘Please select a merchant ID’ and include all the previously entered merchant IDs by the user. This further saves user's time to memorize or store the merchant ID in his records.

FIG. 5B shows a UI 550 configured to display a widget 515 that includes a form field 530 using which the user can enter a transaction amount (exemplarily depicted as ‘155 INR’). The form field 530 may allow the user to enter a numerical input to provide the transaction amount. The user can click the button 520 to submit the transaction amount to the issuer server 235. FIG. 5C shows a UI 560 configured to display a widget 535 that includes a form field 540 using which the user enters MPIN (exemplarily depicted as ****) associated with his bank account and clicks the button 520 to submit the entry input for verification of transaction.

In one embodiment, the issuer server 235 receives the merchant ID, the transaction amount, and the MPIN entered by the user using corresponding UIs via the wireless carrier 255. As explained with reference to FIG. 3, the issuer server 235 verifies the MPIN entered by the user and upon successful verification only, the transaction is carried forward and the transaction amount is debited from the user account.

In one embodiment, the payment server 240 receives the payment transaction request including the merchant ID, the payment card details, and transaction amount from the issuer server 235. The payment server 240 verifies the merchant ID from a mapping table generated by the payment server 240. The creation/generation of the mapping table is explained with reference to FIGS. 6 and 7 hereinafter.

FIG. 6 represents a sequence flow diagram 600 representing an assignment of a merchant ID to a merchant, in accordance with an example embodiment. A merchant ID is assigned to the merchant by the payment server 240 at the time of merchant onboarding to the acquirer bank. At 605, the acquirer server 230 sends a merchant registration request to create a merchant ID to the payment server 240 via a network such as the network 250 of FIG. 2. At 610, a plurality of parameters associated with the merchant are sent to the payment server 240 along with the request to create a merchant ID. It is noted that the operations 605 and 610 can be performed in a single step. The merchant ID request and the merchant parameters are sent using indicative Application Program Interface (API) calls from the acquirer server 230 to the payment server 240. For instance, a request may be in form of:

```
        Request =
        (“apiOperation”:“RequestMerchantID”,“RequestID”:“ABC123”,
“MerchantPan”:“5555444433331110”,“MerchantName”:“TestMerchant1”,
“MCC”:“6531”,“MerchantCity”:“DELHI”,“MerchantPostalCode”:
“110014”,“MAID”:“456782”,“MerchantBrandName”:“MEGAMART”)
```

As mentioned in the exemplary API request above, for a request ID—‘ABC123’, a plurality of parameters associated with the merchant include merchant PAN, merchant name, merchant category code (MCC), merchant city, merchant postal code, MAID, merchant brand name, and the like.

At 615, the payment server 240 is configured to assign a unique merchant ID for the request ID received from the acquirer server 230. An API response from the payment server 240 to the acquirer server 230 may be such as—

```
        Response =
        (“MerchantID”:“12345678”,“Status”:“SUCCESS”,
“MerchantPan”:“5555444433331110”,“RequestID”:“ABC123”)
```

As can be seen from the API response, for the request ID—‘ABC123’, the merchant ID is created as ‘12345678’.

At 620, at least one merchant parameter such as the merchant PAN is mapped to the merchant ID (as shown in the API response). In one embodiment, instead of performing API calls, the Mastercard® payment system may facilitate a plurality of Mastercard integration processors (MIPs) locally installed at each acquirer bank and perform as a link between the Mastercard® payment system interchange network and the processing services. The MIPs may be configured to facilitate on request creation of the merchant ID. In various embodiments, the merchant ID may be generated by an acquirer processor/the acquirer server 230 associated with the acquirer bank.

In various embodiments of the present disclosure, the merchant ID is used to identify the merchant during the normal processing of payment transactions, adjustments, chargebacks, end-of-month fees, and so forth. The merchant ID is different than other merchant account numbers, particularly those that identify merchants to the equipment (e.g., point-of-sale (POS) terminals or any other electronic devices) they use for processing transactions. A merchant with a single merchant processing account number may use several terminals at one location, resulting in one merchant ID and several terminal identification numbers (TIDs).

At 625, the merchant ID and the merchant parameters collectively included as merchant information of a merchant is stored by the payment server 240 as a listing in form of a mapping table. The mapping table includes the listing of plurality of merchant information per merchant that can be utilized during P2M payment transactions. At 630, the merchant PAN mapped to the merchant ID is retrieved from the mapping table during a payment transaction and sent to the acquirer server 230. Operation 630 corresponds to operation 360 of FIG. 3. The acquirer server 230, thereafter, credits the merchant's account with the transaction amount using the merchant PAN. The transaction completes at step 635.

FIG. 7 represents a simplified schematic representation of a mapping table 700 stored in a payment server for verifying a merchant ID for a completion of a payment transaction, in accordance with an example embodiment. As shown, the mapping table 700 includes a listing of plurality of merchant information (as represented by rows 750, 755, 760, 765, and 770) corresponding to a plurality of merchants. The columns of the mapping table 700 represent the plurality of merchant parameters per merchant information. For example, columns include, a request ID 705, a merchant ID 710, a merchant PAN 715, a merchant name 720, a merchant category code (MCC) 725, a merchant city 730, a merchant postal code 735, an MAID 740, and a merchant brand name 745. A row 755 represents that for the request ID—‘ABC124’, merchant ID is ‘12345679’, merchant PAN is ‘5555444433331111’, merchant name is ‘Testmerchant2’, MCC is ‘4122’, merchant city is ‘Mumbai’, merchant postal code is ‘411221’, MAID is ‘534567’ and the merchant brand name is ‘Grocery store’. Likewise, each row represents merchant information uniquely associated with each merchant.

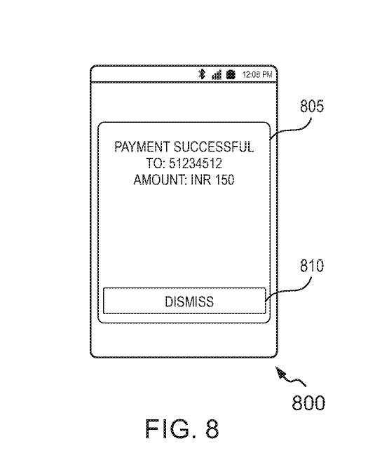

FIG. 8 shows a simplified schematic representation of a UI 800 representing a transaction status of a P2M payment transaction through user's mobile phone 220, in accordance with an example embodiment. More specifically, the UI 800 represents operation 385 of the sequence flow 300 of FIG. 3. The UI 800 displays a widget 805 that includes a notification about the transaction status (e.g., payment successful) of the payment transaction. Upon verification of the merchant ID and retrieval of the merchant PAN from the mapping table, the payment server 240 sends the transaction amount (150 INR of the UI 550 of FIG. 5B) to the acquirer server 230 for crediting the amount to the merchant's account. Upon successful crediting, the acquirer server 230 may notify the payment server 240 of the successful transaction which may further notify the issuer server 235 of the same. The issuer server 235, as shown in the UI 800, may present the successful transaction message via the wireless carrier 255 on the mobile phone 220 of the user. The UI 800 also include a button 810 labeled ‘Dismiss’ to close the UI 800 as well as to opt out from the USSD session for payment transaction.

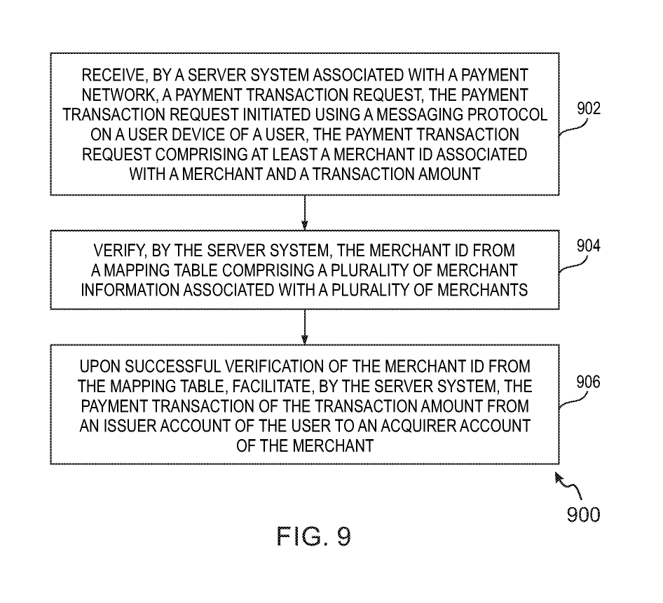

FIG. 9 illustrates a flow diagram of a method 900 for facilitating P2M payment transaction, in accordance with an example embodiment. The method 900 depicted in the flow diagram may be executed by, for example, the at least one server system such as the acquirer server 230, the issuer server 235, and the payment server 240 explained with reference to FIG. 2. Operations of the flow diagram 900, and combinations of operation in the flow diagram 900, may be implemented by, for example, hardware, firmware, a processor, circuitry, and/or a different device associated with the execution of software that includes one or more computer program instructions. The operations of the method 900 are described herein with help of the server systems 230, 235, or 240. It is noted that the operations of the method 900 can be described and/or practiced by using a system other than these server systems. The method 900 starts at operation 902.

At 902, the method 900 includes receiving, by a server system (e.g., the issuer server 235 or the payment server 240) associated with a payment network, a payment transaction request. The payment transaction request is initiated using a messaging protocol on a user device. An example of the messaging protocol is a USSD protocol. Another example of the messaging protocol can be a SMS protocol. The payment transaction request includes a merchant ID and a transaction amount. As explained with reference to FIG. 3, the issuer server 235 transmits the payment transaction request to the payment server 240 over a network for processing the payment transaction. In some embodiments, the payment server 240 can directly receive the payment transaction request from the user.

At 904, the method 900 includes, verifying, by the server system, the merchant ID from a mapping table including a plurality of merchant information associated with a plurality of merchants. As explained with reference to FIGS. 6 and 7, the payment server 240 maintains the mapping table with a listing of a plurality of merchant information. Each merchant information includes a mapping of a plurality of merchant parameters and the merchant ID assigned to the merchant. In an embodiment, verifying the merchant ID includes a step of matching the merchant ID received as part of the payment transaction request with entries in the mapping table. The merchant ID is further used to retrieve one of the merchant parameters of the merchant from the mapping table to credit the transaction amount to the merchant's account.

In an alternate embodiment where the server system is the issuer server, the issuer server can perform the verification of the merchant ID by sending a verification request to the payment server to which the mapping table is accessible. In still an alternate embodiment, the issuer server can request for access to the mapping table from the payment server for verifying the merchant ID.

At 906, the method 900 includes facilitating the payment transaction of the transaction amount from an issuer account of a user to an acquirer account of a merchant upon successful verification of the merchant ID. The method 900 ends at operation 906.

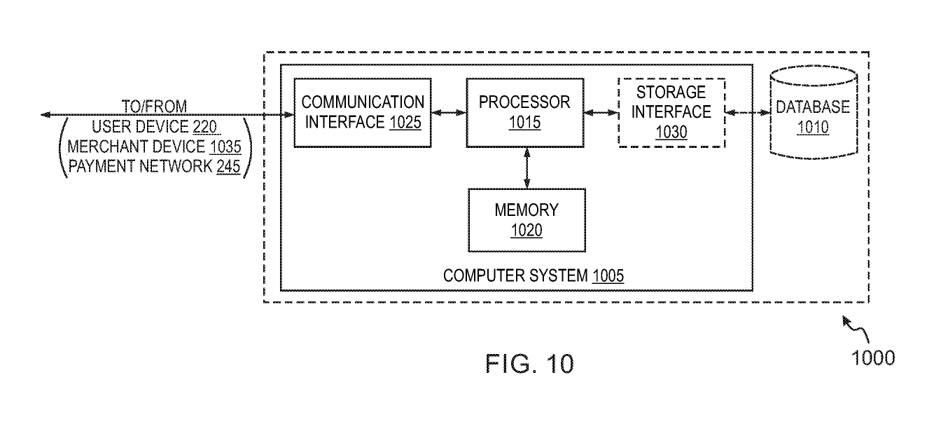

FIG. 10 is a simplified block diagram of a server system used for P2M payment transaction, in accordance with one embodiment of the present disclosure. The server system 1000 is an example of a server system that is a part of the payment network 245. Examples of the server system 1000 includes, but not limited to, the acquirer server 230, the issuer server 235, and the payment server 240. The server system 1000 includes a computer system 1005 and a database 1010.

The computer system 1005 includes at least one processor 1015 for executing instructions. Instructions may be stored in, for example, but not limited to, a memory 1020. The processor 1015 may include one or more processing units (e.g., in a multi-core configuration).

The processor 1015 is operatively coupled to a communication interface 1025 such that computer system 1005 is capable of communicating with a remote device such as the user mobile phone 220 or communicating with any entity within the payment network 245. For example, the communication interface 1025 may receive the payment transaction requests from the mobile phone 220 associated with a user.

The processor 1015 may also be operatively coupled to the database 1010. The database 1010 is any computer-operated hardware suitable for storing and/or retrieving data, such as, but not limited to, transaction data generated as part of sales activities conducted over the bankcard network including data relating to merchants, account holders or customers, and purchases. The database 1010 may also store information related to a plurality of user's payment accounts. Each user account data includes at least one of a cardholder name, a cardholder address, an account number, MPIN, and other account identifier. The database 1010 may also store a mapping table with a listing of a plurality of merchant information. Each merchant information may further include a plurality of merchant parameters and the merchant ID associated with each merchant registered to use the payment network. The database 1010 may also include instructions for settling transactions including merchant bank account information. The database 1010 may include multiple storage units such as hard disks and/or solid-state disks in a redundant array of inexpensive disks (RAID) configuration. The database 1010 may include a storage area network (SAN) and/or a network attached storage (NAS) system.

In some embodiments, the database 1010 is integrated within computer system 1005. For example, computer system 1005 may include one or more hard disk drives as the database 1010. In other embodiments, the database 1010 is external to computer system 1005 and may be accessed by the computer system 1005 using a storage interface 1030. The storage interface 1030 is any component capable of providing the processor 1015 with access to the database 1010. The storage interface 1030 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 1015 with access to the database 1010.

The processor 1015 is configured to perform verification of merchant ID, payment card details, transaction amount, and MPIN for authentication of the payment transaction request by communicating with the database 1010. For instance, the processor 1015 is configured to facilitate the authentication by verifying the payment card details from corresponding information stored in the database 1010. For example, the processor 1015 can verify the payment card number, PIN, validity of the payment card by accessing respective information from the database 1010. The processor 1015 is further configured to approve the transaction amount by checking the available balance in the issuer account of the user, as stored in the database 1010. The processor 1015 is further configured to verify the MPIN entered by the user from corresponding MPIN stored in the database 1010. Thereafter, the processor 1015 is configured to facilitate the payment transaction of the transaction amount from the issuer account of the user to acquirer account of the merchant. The processor 1015 is configured to notify the user device 220 and merchant device 1035 of the transaction status via the communication interface 1025.

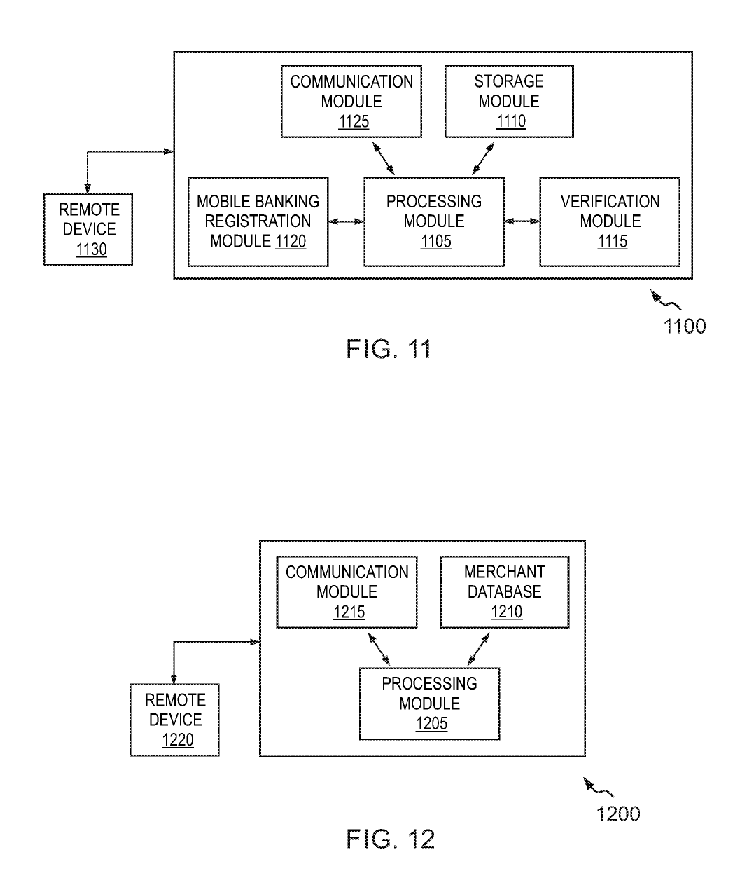

FIG. 11 is a simplified block diagram of an issuer server 1100 for P2M payment transaction, in accordance with one embodiment of the present disclosure. The issuer server 1100 is an example of the issuer server 235 of FIG. 2, or may be embodied in the issuer server 235. The issuer server 1100 is associated with an issuer bank/issuer, in which a user may have an account, and which provides a USSD based electronic payment transaction facility. The issuer server 1100 includes a processing module 1105 operatively coupled to a storage module 1110, a verification module 1115, a mobile banking registration module 1120, and a communication module 1125. The components of the issuer server 1100 provided herein may not be exhaustive, and that the issuer server 1100 may include more or fewer components than that of depicted in FIG. 11. Further, two or more components may be embodied in one single component, and/or one component may be configured using multiple sub-components to achieve the desired functionalities. Some components of the issuer server 1100 may be configured using hardware elements, software elements, firmware elements, and/or a combination thereof.

The storage module 1110 is configured to store machine executable instructions to be accessed by the processing module 1105. Additionally, the storage module 1110 stores information related to, contact information of the user, bank account number, BINs, payment card details, mobile numbers of the users for facilitating mobile banking, USSD codes, internet banking information, PINS, MPINs for mobile banking, and the like. This information is retrieved by the processing module 1105 for cross-verification during payment transactions.

The mobile banking registration module 1120 is configured to facilitate a user to register/enroll for USSD based payment transactions, IMPS based payment transactions and the like using his mobile phone number. In one embodiment, the mobile banking registration module 1120 includes logics to generate MPIN that is uniquely associated with each registered mobile phone number of the user and needs to be authenticated for processing the mobile banking based payment transactions. The MPINs generated by the mobile banking registration module 1120 are stored in the storage module 1110 for later retrieval by the processing module 1105 for verification purposes.

The processing module 1105 is configured to communicate with one or more remote devices such as the remote device 1130 using the communication module 1125 over a network such as the network 250 or the payment network 245 of FIG. 2. The examples of the remote device 1130 include, the merchant device 1035, the user device 220, the wireless carrier 255, the payment server 240, the acquirer server 230, other computing systems of issuer and payment network 245 and the like. The communication module 1125 is capable of facilitating such operative communication with the remote devices and cloud servers using API (Application Program Interface) calls. The communication module 1125 is further configured to cause display of user interfaces (UIs) on the user device 220 via the wireless carrier 255 to enable the user to enter USSD code, payment card details, transaction amount, merchant ID, MPIN, etc. on the various UIs of the user device 220. In various embodiments, a plurality of options can be displayed such as account balance inquiry, mini account statement, one-time password (OTP) generation, and the like for user selection by the communication module 1125 on the user device 220.

The processing module 1105, in conjunction with the verification module 1115, is configured to verify the MPIN (e.g., whether the four-digit numeric code matches the MPIN issued by the issuer), the sufficient funds in the issuer account, payment card details and the like. Upon successful verification only, the payment transaction is processed further by the processing module 1105 by debiting the transaction amount from the issuer account of the user. The processing module 1105 sends the merchant ID, the payment card details, and the transaction amount to the payment server 240 over a network such as the network 250 or the payment network 245 via the communication module 1125.

FIG. 12 is a simplified block diagram of an acquirer server 1200 used for P2M payment transaction, in accordance with one embodiment of the present disclosure. The acquirer server 1200 is associated with the acquirer bank of a merchant where the merchant has established an account to accept payment using the USSD based payment transactions. The acquirer server 1200 is an example of the acquirer server 230 of FIG. 2, or may be embodied in the acquirer server 230. Further, the acquirer server 1200 is configured to facilitate USSD based payment transaction with the issuer server 1100 using the payment network 245 of FIG. 2. The acquirer server 1200 includes a processing module 1205 communicably coupled to a merchant database 1210 and a communication module 1215. The components of the acquirer server 1200 provided herein may not be exhaustive, and that the acquirer server 1200 may include more or fewer components than that of depicted in FIG. 12. Further, two or more components may be embodied in one single component, and/or one component may be configured using multiple sub-components to achieve the desired functionalities. Some components of the acquirer server 1200 may be configured using hardware elements, software elements, firmware elements, and/or a combination thereof.

The merchant database 1210 includes one or more merchant parameters, such as, but not limited to, a merchant primary account number (PAN), a merchant name, a merchant category code (MCC), a merchant city, a merchant postal code, an MAID, a merchant brand name, a request ID to generate a merchant ID, terminal identification numbers (TIDs) associated with merchant equipment (e.g., the POS terminals or any other merchant electronic devices) used for processing transactions and the like. The processing module 1205 is configured to use the merchant ID or any other merchant parameter such as the merchant PAN to identify the merchant during the normal processing of payment transactions, adjustments, chargebacks, end-of-month fees and so forth. The processing module 1205 may be configured to store and update the merchant parameters in the merchant database 1210 for later retrieval.

In an embodiment, the communication module 1215 is capable of facilitating operative communication with the remote device 1220 (e.g., the issuer server 1100, the merchant device 1035, the user device 220, and/or the payment server 240) using API calls. The communication may be achieved over a communication network, such as the network 250. For example, the processing module 1205 may send a merchant ID registration request and the merchant parameters (retrieved from the merchant database 1210) to the payment server 240 via the communication module 1215. Upon creation of the merchant ID by the payment server 240, the processing module 1205 is configured to receive the merchant PAN mapped to the merchant ID to credit the transaction amount to the acquirer account of the merchant.

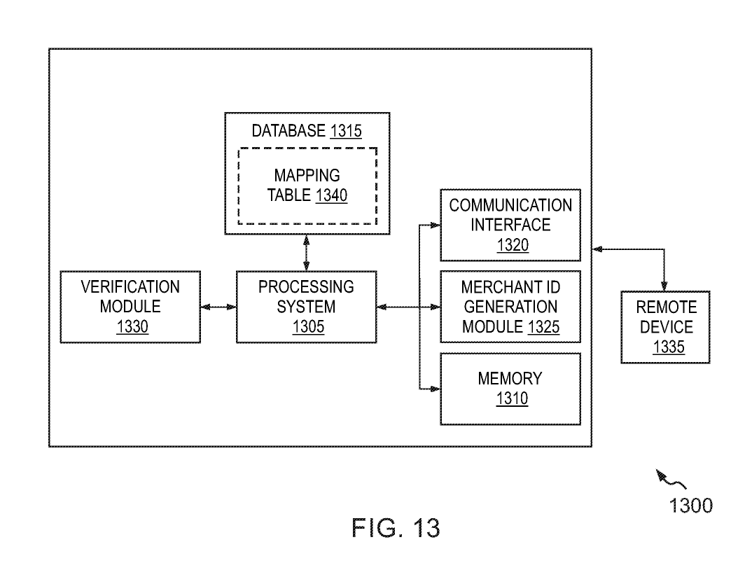

FIG. 13 is a simplified block diagram of a payment server 1300 used for P2M payment transaction, in accordance with one embodiment of the present disclosure. The payment server 1300 may correspond to payment server 240 of FIG. 2. As explained with reference to FIG. 2, the payment server 240 is associated with a payment network 245. The payment network 245 may be used by issuer server 1100 and acquirer server 1200 as a payment interchange network. Examples of payment interchange network include, but not limited to, Mastercard® payment system interchange network. The payment server 1300 includes a processing system 1305 configured to extract programming instructions from a memory 1310 to provide various features of the present disclosure. The components of the payment server 1300 provided herein may not be exhaustive, and that the payment server 1300 may include more or fewer components than that of depicted in FIG. 13. Further, two or more components may be embodied in one single component, and/or one component may be configured using multiple sub-components to achieve the desired functionalities. Some components of the payment server 1300 may be configured using hardware elements, software elements, firmware elements, and/or a combination thereof.

Via a communication interface 1320, the processing system 1305 receives payment transaction details from a remote device 1335 such as the issuer server 1100 or the user device 220. The communication may be achieved through API calls, without loss of generality. A merchant ID generation module 1325 is operatively coupled to the processing system 1305. The merchant ID generation module 1325 is configured to generate the merchant ID based on the request received from the acquirer serer 1200 over the API calls. Without loss of generality, the merchant ID and other merchant parameters are stored in a mapping table 1340 which is stored in a database 1315 to be utilized by the processing system 1305 to retrieve merchant information. Apart from the mapping table 1340, the database 1315 stores the merchant parameters, payment card details, BINs, MPINs, the transaction amount, acquirer account information, transaction records, merchant account information, and the like. The merchant ID, the payment card details, the issuer account balance, the MPINs, etc., are verified using a verification module 1330. The verification module 1330 may include one or more predefined rule sets using which the processing system 1305 can process the verification. Further, the processing system 1305, upon successful verification, sends transaction amount and the merchant parameters to the acquirer server 1200 for crediting the merchant account with the transaction amount. The processing system 1305 is further configured to notify the remote device 1335 of the transaction status via the communication interface 1320. In one embodiment, the processing system 1305 may facilitate a dedicated application capable of being installed on the merchant device 1035. The merchant may be enabled to view the transaction status using the application on his device. The merchant may access the application using a web link as well, instead of having a need to install the application on his device.

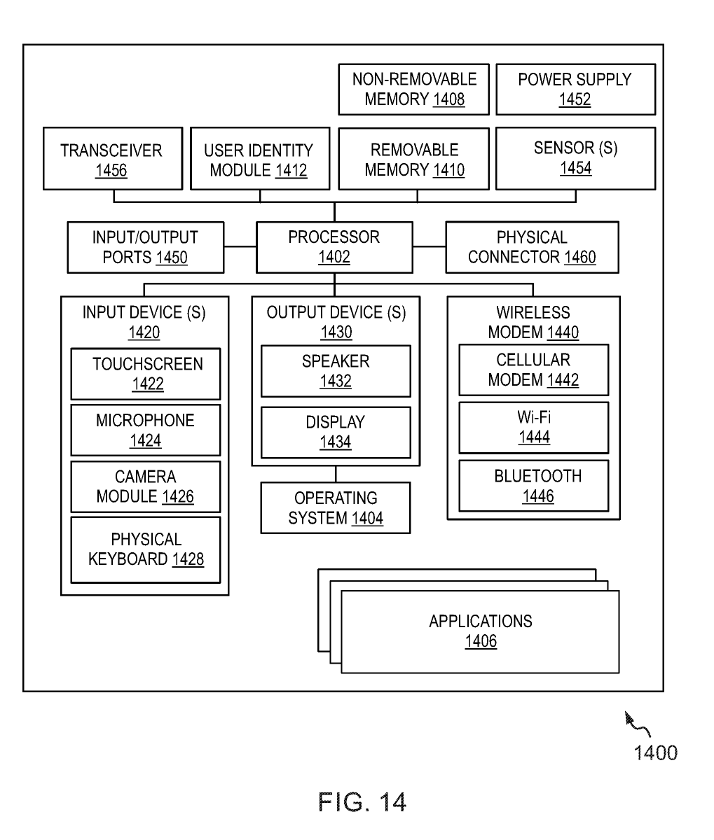

FIG. 14 shows simplified block diagram of a user device, for example, a mobile phone 1400 (also mobile phone 220) capable of implementing the various embodiments of the present disclosure. For example, the mobile phone 1400 may correspond to a handheld device of the user 215. The mobile phone 1400 is depicted to include one or more applications 1406.

It should be understood that the mobile phone 1400 as illustrated and hereinafter described is merely illustrative of one type of device and should not be taken to limit the scope of the embodiments. As such, it should be appreciated that at least some of the components described below in connection with that the mobile phone 1400 may be optional and thus in an example embodiment may include more, less or different components than those described in connection with the example embodiment of the FIG. 14. As such, among other examples, the mobile phone 1400 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated mobile phone 1400 includes a controller or a processor 1402 (e.g., a signal processor, microprocessor, ASIC, or other control and processing logic circuitry) for performing such tasks as signal coding, data processing, image processing, input/output processing, power control, and/or other functions. An operating system 1404 controls the allocation and usage of the components of the mobile phone 1400 and support for one or more applications programs (see, applications 1406), that implements one or more of the innovative features described herein. The applications 1406 may include common mobile computing applications (e.g., telephony applications, email applications, calendars, contact managers, web browsers, messaging applications such as USSD messaging or SMS messaging or SIM Tool Kit (STK) application) or any other computing application.

The illustrated mobile phone 1400 includes one or more memory components, for example, a non-removable memory 1408 and/or removable memory 1410. The non-removable memory 1408 and/or removable memory 1410 may be collectively known as database in an embodiment. The non-removable memory 1408 can include RAM, ROM, flash memory, a hard disk, or other well-known memory storage technologies. The removable memory 1410 can include flash memory, smart cards, or a Subscriber Identity Module (SIM). The one or more memory components can be used for storing data and/or code for running the operating system 1404 and the applications 1406. The mobile phone 1400 may further include a user identity module (UIM) 1412. The UIM 1412 may be a memory device having a processor built in. The UIM 1412 may include, for example, a subscriber identity module (SIM), a universal integrated circuit card (UICC), a universal subscriber identity module (USIM), a removable user identity module (R-UIM), or any other smart card. The UIM 1412 typically stores information elements related to a mobile subscriber. The UIM 1412 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The mobile phone 1400 can support one or more input devices 1420 and one or more output devices 1430. Examples of the input devices 1420 may include, but are not limited to, a touch screen/a display screen 1422 (e.g., capable of capturing finger tap inputs, finger gesture inputs, multi-finger tap inputs, multi-finger gesture inputs, or keystroke inputs from a virtual keyboard, or keypad), a microphone 1424 (e.g., capable of capturing voice input), a camera module 1426 (e.g., capable of capturing still picture images and/or video images), and a physical keyboard 1428. Examples of the output devices 1430 may include, but are not limited to a speaker 1432 and a display 1434. Other possible output devices can include piezoelectric or other haptic output devices. Some devices can serve more than one input/output function. For example, the touch screen 1422 and the display 1434 can be combined into a single input/output device.

A wireless modem 1440 can be coupled to one or more antennas (not shown in the FIG. 14) and can support two-way communications between the processor 1402 and external devices, as is well understood in the art. The wireless modem 1440 is shown generically and can include, for example, a cellular modem 1442 for communicating at long range with the mobile communication network, a Wi-Fi compatible modem 1444 for communicating at short range with an external Bluetooth-equipped device or a local wireless data network or router, and/or a Bluetooth-compatible modem 1446. The wireless modem 1440 is typically configured for communication with one or more cellular networks, such as a GSM network for data and voice communications within a single cellular network, between cellular networks, or between the mobile phone 1400 and a public switched telephone network (PSTN).

The mobile phone 1400 can further include one or more input/output ports 1450, a power supply 1452, one or more sensors 1454 for example, an accelerometer, a gyroscope, a compass, or an infrared proximity sensor for detecting the orientation or motion of the mobile phone 1400 and biometric sensors for scanning biometric identity of an authorized user, a transceiver 1456 (for wirelessly transmitting analog or digital signals) and/or a physical connector 1460, which can be a USB port, IEEE 1294 (FireWire) port, and/or RS-232 port. The illustrated components are not required or all-inclusive, as any of the components shown can be deleted and other components can be added.

The disclosed methods with reference to FIGS. 3 to 8, or one or more operations of the flow diagram 900 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad spirit and scope of the disclosure. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server systems 230, 235, and 240 its various components such as the computer system 1005 and the database 1010 may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Various embodiments of the disclosure, as discussed above, may be practiced with steps and/or operations in a different order, and/or with hardware elements in configurations, which are different than those which, are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A method comprising:
receiving, by a server system associated with a payment network, a payment transaction request, the payment transaction request initiated using a messaging protocol on a user device of a user, the payment transaction request comprising at least a merchant ID associated with a merchant and a transaction amount;
verifying, by the server system, the merchant ID from a mapping table comprising merchant information associated with a plurality of merchants; and
upon successful verification of the merchant ID from the mapping table, facilitating, by the server system, a payment transaction of the transaction amount from an issuer account of the user to an acquirer account of the merchant.

2. The method according to claim 1, wherein the messaging protocol is an Unstructured Supplementary Service Data (USSD) protocol.

3. The method according to claim 2, wherein the server system is a payment server, and wherein the method further comprises:
receiving a registration request for registering the merchant with the payment network, the registration request comprising a plurality of parameters associated with the merchant;
assigning the merchant ID to the merchant; and
mapping the plurality of parameters to the merchant ID in the mapping table as merchant information associated with the merchant.

4. The method according to claim 3, wherein the plurality of parameters comprises at least one of a merchant name, a merchant category code, a merchant city, a merchant postal code, a merchant brand name, a merchant primary account number (PAN), an MAID, and a request ID.

5. The method according to claim 3, wherein verifying the merchant ID comprises matching the merchant ID received as part of the payment transaction request to entries in the mapping table.

6. The method according to claim 3, wherein facilitating the payment transaction comprises:
retrieving at least one parameter of the plurality of parameters mapped to the merchant ID; and
sending the at least one parameter to an acquirer server of the payment network to facilitate the payment transaction to the acquirer account of the merchant.

7. The method according to claim 3, wherein the merchant ID is a 8 character code.

8. The method according to claim 2, wherein the payment transaction request comprises information of a selected payment card from at least one payment card associated with the user.

9. The method according to claim 8, wherein the at least one payment card comprises at least one of a credit card, a debit card, and a prepaid card.

10. The method according to claim 2, wherein the server system is an issuer server, and wherein receiving the payment transaction request from the user device comprises:
receiving a message code from the user device via a wireless carrier using the messaging protocol; and
facilitating display of at least one option for merchant payment on a display screen of the user device for user selection, wherein facilitating display comprises transmitting a message comprising the at least one option for the merchant payment to the user device via the wireless carrier,
and wherein verifying the merchant ID from the mapping table comprises sending a request to a payment server of the payment network to verify the merchant ID from the mapping table accessible to the payment server.

11. The method according to claim 10, wherein receiving the payment transaction request further comprises:
receiving a mobile personal identification number (MPIN) associated with the issuer account of the user;
verifying the MPIN; and
upon successful verification of the MPIN, approving the transaction amount for the payment transaction.

12. A server system in a payment network, the system comprising:
a communication interface for receiving a payment transaction request, the payment transaction request initiated using a messaging protocol on a user device of a user, the payment transaction request comprising at least a merchant ID associated with a merchant and a transaction amount;
a memory comprising executable instructions; and
a processor communicatively coupled to the communication interface and configured to execute the instructions to cause the server system to at least:
verify the merchant ID from a mapping table comprising merchant information associated with a plurality of merchants; and
upon successful verification of the merchant ID from the mapping table, facilitate a payment transaction of the transaction amount from an issuer account of the user to an acquirer account of the merchant.

13. The server system according to claim 12, wherein the messaging protocol is an Unstructured Supplementary Service Data (USSD) protocol.

14. The server system according to claim 13, further comprising a database for storing the mapping table comprising the merchant information, wherein the merchant information comprises a plurality of parameters associated with a merchant.

15. The server system according to claim 14, wherein the plurality of parameters comprises at least one of a merchant name, a merchant category code, a merchant city, a merchant postal code, a merchant brand name, a merchant primary account number (PAN), an MAID, and a request ID.

16. The server system according to claim 13, wherein the server system is a payment server, and wherein the server system is further caused to at least:
receive a registration request for registering the merchant with the payment network, the registration request comprising a plurality of parameters associated with the merchant;
assign the merchant ID to the merchant; and
map the plurality of parameters to the merchant ID in the mapping table as merchant information associated with the merchant.

17. The server system according to claim 13, wherein the server system is caused to verify the merchant ID by matching the merchant ID received as part of the payment transaction request with entries in the mapping table.

18. The server system according to claim 13, wherein the payment transaction request comprises information of a selected payment card from at least one payment card associated with the user.

19. A server system in a payment network, the system comprising:
a database for storing a mapping table comprising merchant information associated with a plurality of merchants;
a communication interface for receiving a payment transaction request, the payment transaction request initiated using an Unstructured Supplementary Service Data (USSD) protocol on a user device of a user, the payment transaction request comprising at least a merchant ID associated with a merchant and a transaction amount;
a memory comprising executable instructions; and
a processor communicably coupled to the communication interface and the database, the processor configured to execute the instructions to cause to server system to:
verify the merchant ID from the mapping table; and
upon successful verification of the merchant ID from the mapping table, facilitate a payment transaction of the transaction amount from an issuer account of the user to an acquirer account of the merchant.

20. The server system according to claim 19, wherein the merchant information comprises a plurality of parameters associated with a merchant, the plurality of parameters comprising at least one of a merchant name, a merchant category code, a merchant city, a merchant postal code, a merchant brand name, a merchant primary account number (PAN), an MAID, and a request ID.
